(19) United States
(12) Patent Application Publication
(10) Pub. No.: US 2024/0367484 A1
(43) Pub. Date: Nov. 7, 2024

(54) REFRIGERANT LOOPS AND RELATED CONTROL SYSTEMS FOR HEATING AND COOLING

(71) Applicants: DENSO International America, Inc., Southfield, MI (US); DENSO CORPORATION, Kariya (JP)

(72) Inventors: Yilin TIAN, Novi, MI (US); Kengo SUGIMURA, West Bloomfield, MI (US)

(21) Appl. No.: 18/380,010

(22) Filed: Oct. 13, 2023

Related U.S. Application Data
(60) Provisional application No. 63/534,682, filed on Aug. 25, 2023.
(60) Provisional application No. 63/499,931, filed on May 3, 2023.

(51) Int. Cl. B60H 1/00

(52) U.S. Cl. CPC B60H 1/00914; B60H 2001/00928

(57) ABSTRACT

A refrigerant loop including: a main loop and a bypass loop. The main loop includes: at least one heat exchanger; a first expansion valve configured to control flow of a refrigerant through the refrigerant loop; a compressor; a sensor for detecting at least one of a discharge superheat (SH) from the compressor, a discharge temperature, a discharge pressure, a suction SH, a suction temperature, a suction pressure, a temperature of a refrigerant, and a time period. The bypass loop includes a second expansion valve configured to control flow of the refrigerant through the refrigerant loop. A controller controls the opening and closing of the first expansion valve and the second expansion valve based on the detected discharge SH, the discharge temperature, the discharge pressure, the suction SH, the suction temperature, the suction pressure, the temperature of the refrigerant, and the time period.

### CROSS-REFERENCE TO RELATED APPLICATION

The present disclosure claims the benefit of Provisional Patent Application No. 63/534,682 filed on Aug. 25, 2023 and entitled “REFRIGERANT LOOPS AND RELATED CONTROL SYSTEMS FOR HEATING AND COOLING,” and the benefit of Provisional Patent Application No. 63/499,931 filed on May 3, 2023 and entitled “HEAT PUMP SYSTEM CONTROL FOR IMPROVED COLD AMBIENT WARM-UP PERFORMANCE,” the contents of which are incorporated by reference in their entirety.

### TECHNICAL FIELD

The present specification generally relates to refrigerant loops for heating and cooling and, more specifically, refrigerant loops for heating a vehicle on start-up.

### BACKGROUND

Vehicles include heating systems for providing heating and/or cooling to various parts of the vehicle, including the passenger compartment. Heating systems require time to heat up to provide heat to the various parts of the vehicle, and require more time as the ambient temperature reduces. For electric vehicles, it is desirable to heat up for a predetermined amount of time before unplugging and/or driving the vehicle to optimize range and performance of the vehicle. Accordingly, a need exists for improved heating systems that reduce the time required to heat up.

### SUMMARY

According to a first aspect, a refrigerant loop includes: a main loop including: at least one heat exchanger; a first expansion valve configured to control flow of a refrigerant through the refrigerant loop; a compressor; a sensor for detecting at least one of a discharge superheat (SH) from the compressor, a discharge temperature, a discharge pressure, a suction SH, a suction temperature, a suction pressure, a temperature of a refrigerant, and a time period; a bypass loop including a second expansion valve configured to control flow of the refrigerant through the refrigerant loop; and a controller that controls the opening and closing of the first expansion valve and the second expansion valve based on the detected discharge SH, the discharge temperature, the discharge pressure, the suction SH, the suction temperature, the suction pressure, the temperature of the refrigerant, and the time period.

According to a second aspect, a method of operating a refrigerant loop, the method includes: defining an initial opening of an expansion valve, wherein the initial opening is substantially open or substantially closed; detecting a characteristic of a discharge side of a compressor; determining whether the characteristic of the discharge side of the compressor is outside of a predetermined range of a threshold value; and changing a size of the opening of the expansion valve in response to the characteristic of the discharge side of the compressor being outside of the predetermined range of the threshold value.

According to a third aspect, a method of operating a refrigerant loop, the method includes: determining a characteristic of a discharge side of a compressor; controlling an expansion valve using a first method, wherein the first method includes control logic that is based on the characteristic of a discharge side of the compressor; determining a characteristic of a suction side of the compressor; and in response to the characteristic of the suction side of the compressor meeting predefined criteria, controlling the expansion valve using a second method, wherein the second method includes control logic is based on the characteristic of the suction side of the compressor.

According to a fourth aspect, a method of operating a refrigerant loop, the method includes: detecting a condition associated with an operating environment of the refrigerant loop; defining an operation mode and associated parameters for at least one of a first expansion valve and a second expansion valve based on the detected condition, wherein the associated parameters include: a first initial opening for the first expansion valve, wherein the initial opening for the first expansion valve is substantially open or substantially closed; a second initial opening for the second expansion valve, wherein the initial opening for the expansion valve is substantially open or substantially closed; setting the first expansion valve to the first initial opening and the second expansion valve to the second initial opening; determining a characteristic of a discharge side of the compressor; controlling the opening of at least one of the first expansion valve and the second expansion valve based on the characteristic of the discharge side of the compressor; determining a characteristic of a suction side of the compressor; in response to the characteristic of the suction side of the compressor meeting a predetermined characteristic, controlling the opening of at least one of the first expansion valve an the second expansion valve based on the characteristic of suction discharge.

According to a fifth aspect, a refrigerant loop includes: a main loop includes: at least one heat exchanger; a first expansion valve configured to control flow of a refrigerant through the refrigerant loop; a compressor; a first sensor configured to output a characteristic of a suction side of the compressor; a second sensor configured to output a characteristic of a discharge side of the compressor; a bypass loop including a second expansion valve configured to control flow of the refrigerant through the refrigerant loop; and a controller configured to: in response to a condition associated with an operating environment of the refrigerant loop, control the opening and closing of at least one of the first expansion valve and the second expansion valve using a first method, wherein in the first method includes control logic that is based on the characteristic of the discharge side of the compressor; and in response to a characteristic of a suction side of the compressor meeting a predefined criteria, switching control of the opening and closing of at least one of the first expansion valve and the second expansion valve using a second method, wherein in the second method includes control logic that is based on the characteristic of the suction side of the compressor.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a heating system for a vehicle, according to one or more embodiments shown and described herein;

FIG. 2 schematically depicts a control system for controlling the heating system of FIG. 1, according to one or more embodiments shown and described herein;

FIG. 3 schematically depicts a flowchart of a method of operating the heating system of FIG. 1, according to one or more embodiments shown and described herein; and

FIG. 4 schematically depicts a flowchart of another method of operating the heating system of FIG. 1, according to one or more embodiments shown and described herein.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

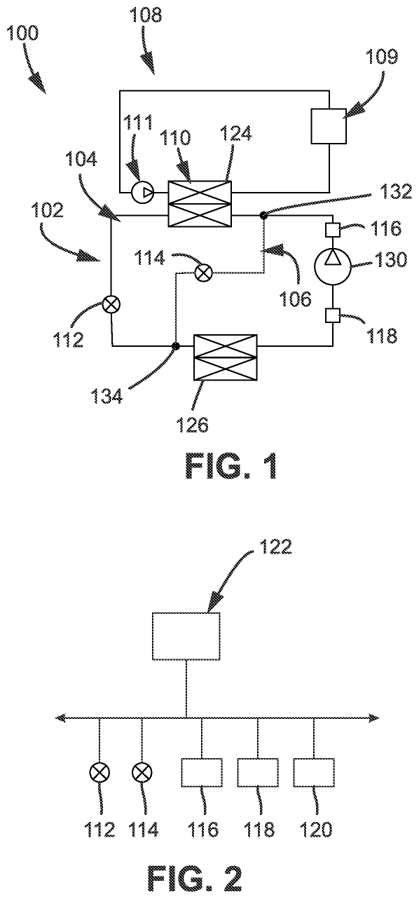

Embodiments described herein are directed to a heating system that includes a control system for controlling an opening and closing of at least one expansion valve to control the flow of refrigerant through a compressor. Any suitable type of refrigerant is contemplated including but not limited to R290, 1234yf, R134a, and R152. The refrigerant flow is controlled to increase a rate at which the heating system heats up, or the ability of the heating system to transfer heat. The heating system may be implemented in a vehicle, such as a car, SUV, truck, air craft (e.g., airplane, helicopter), bus, boat, or the like so that, when the vehicle starts up, the heating system may transfer heat to other parts of the vehicle in a shorter amount of time than a traditional heating system without the disclosed control system. Additional details of the heating system are described below with relation to FIGS. 1-3.

Referring now to FIG. 1, a heating system 100 is illustrated according to one or more embodiments described herein. The heating system 100 may generally include a refrigerant loop 102 including a main loop 104 and a bypass loop 106. In such embodiments, the heating system 100 may be a heat pump, for example, for electric vehicles. The heating system 100 may include additional loops, such as a coolant loop 108, connected to the refrigerant loop 102 at a heat exchanger to allow exchange of heat between the refrigerant loop 102 and the coolant loop 108. The coolant loop 108 may include a heat pump, HVAC, or other heating device 109, and a first compressor, or coolant pump, 111 for regulating temperature in the coolant loop 108 that transfers heat with the refrigerant loop 102 and dispenses heat through the heating device 109. The refrigerant loop 102 may include at least one heat exchanger 110, a first expansion valve 112, a second expansion valve 114, a second compressor 130, a first sensor 116, a second sensor 118, an external sensor 120, and a controller 122. Referring briefly to FIG. 2, the controller 122 may be communicatively coupled to the first sensor 116, the second sensor 118, the external sensor 120, the first expansion valve 112, and the second expansion valve 114 to allow exchange of signals therebetween.

Referring back to FIG. 1, the at least one heat exchanger 110 of the main loop 104 may include a first heat exchanger 124 positioned between one of the sensors 116, 118 and the first expansion valve 112, and a second heat exchanger 126 positioned between the first expansion valve 112 and the second compressor 130. The first heat exchanger 124 may exchange heat between the refrigerant loop 102 and the coolant loop 108. The second heat exchanger 126 may exchange heat between the refrigerant loop 102 and another loop. The first expansion valve 112 may be configured to control flow of a refrigerant through the main loop 104 of the refrigerant loop 102. The second expansion valve 114 may be configured to control flow of the refrigerant through the bypass loop 106 of the refrigerant loop 102. The second expansion valve 114 may have an opening with a size that is greater than a size of an opening of the first expansion valve 112. The size of the opening of the expansion valves 112, 114 may be a cross-sectional area of the valve that is perpendicular to the fluid flow through the refrigerant loop and that the refrigerant flows through, where an increase in the size of the opening increases refrigerant flow, and a decrease in the size of the opening decreases refrigerant flow. The size of the opening of each of the expansion valves 112, 114, can be reduced or expanded, for example, the size of the opening reduced from a max opening that allows max fluid flow through the expansion valve. Each expansion valve 112, 114 may be opened and closed between a fully open position allowing max fluid flow through the valve and not reducing the fluid flow through the loop, and a fully closed position that completely restricts fluid flow through the expansion valve 112, 114. The position of each expansion valve 112, 114 may be moved to any position between a substantially open position and a substantially closed position, where in the substantially open position allows for between 50% and 100% of max fluid flow through the expansion valve, 112, 114, and the substantially closed position allows for between 0% of max fluid flow and 30% max fluid flow. For example, the substantially closed position may be 5% of max fluid flow through the expansion valve. In some embodiments, the substantially closed position may exclude 0%. Each of the expansion valves 112, 114 may be controlled by the controller 122 under a coupling logic, proportional logic, or independent logic with the same or separate control signals from the controller 122.

The first sensor 116 may be positioned at a discharge side of the second compressor 130. The first sensor 116 may be configured to detect at least one of a discharge superheat (SH) from the second compressor 130, a discharge pressure, and a discharge temperature. The second sensor 118 may be positioned at a suction side of the second compressor 130 and is configured to detect at least one of a suction superheat, a suction quality, a suction pressure, and a suction temperature of the second compressor 130, where the controller 122 determines whether the detected value passes a second threshold value. The second threshold value, for example, may be 0° C. As used herein, passing the threshold value may include being at or above the threshold value, or at or below the threshold value. Passing the threshold may include going from above the threshold to below the threshold, or vice versa. In embodiments, the controller 122 may determine whether the detected value(s) is outside of a predetermined range of the threshold value. The predetermined range may have a low end value that is less than a high end value, where the threshold value may be equal to the low end value, equal to the high end value, or positioned between the low end value and the high end value.

Each of the first expansion valve 112 and the second expansion valve 114 may have openings of which a size of the openings is controlled based on the detected discharge superheat, discharge pressure, discharge temperature, suction superheat, suction quality, suction pressure, and/or suction temperature. The external sensor 120 may be configured to detect an ambient temperature. The ambient temperature may be an air temperature in or around the vehicle, such as inside a passenger cabin of a vehicle, an engine compartment, or an exterior air temperature of the vehicle. The first and second expansion valves 112, 114 may additionally or alternatively be controlled based on the detected ambient temperature. In some embodiments, either of the first sensor 116 and the second sensor 118 may be configured to detect a speed of the compressor, such as a rotational speed.

The controller 122 may be configured to control an opening and closing of the first expansion valve 112 based on the at least one of detected discharge SH, the discharge pressure, and the discharge temperature, the controller 122 changes a size of an opening of the first expansion valve 112 when at least one of the detected discharge superheat, the discharge pressure, and the discharge temperature passes a first threshold value. The controller 122 may include an actuator configured to open and/or close the connected valves, along with a processor that outputs signals to the actuator to act based upon the sensed conditions or thresholds, as disclosed herein.

In this disclosure, the terms “controller” and “system” may refer to, be part of, or include processor hardware (shared, dedicated, or group) that executes code and memory hardware (shared, dedicated, or group) that stores code executed by the processor hardware. The code is configured to provide the features of the controller and systems described herein. In one example, the controller may include a processor, memory, and non-volatile storage. The processor may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. The memory may include a single memory device or a plurality of memory devices including, but not limited to, random access memory (“RAM”), volatile memory, non-volatile memory, static random-access memory (“SRAM”), dynamic random-access memory (“DRAM”), flash memory, cache memory, or any other device capable of storing information. The non-volatile storage may include one or more persistent data storage devices such as a hard drive, optical drive, tape drive, non-volatile solid-state device, or any other device capable of persistently storing information. The processor may be configured to read into memory and execute computer-executable instructions embodying one or more software programs residing in the non-volatile storage. Programs residing in the non-volatile storage may include or be part of an operating system or an application, and may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL. The computer-executable instructions of the programs may be configured, upon execution by the processor, to cause the processor to output signals that cause the actuator to open or close a respective valve, for example.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied on a tangible medium, e.g., one or more modules of computer program instructions, encoded on one or more computer storage media for execution by, or to control the operation of, a data processing apparatus. A computer storage medium can be, or be included in, a computer-readable storage device, a computer-readable storage substrate, a random or serial access memory array or device, or a combination of one or more of them. The computer storage medium can also be, or be included in, one or more separate components or media (e.g., multiple CDs, disks, or other storage devices). The computer storage medium may be tangible and non-transitory.

A computer program (also known as a program, software, software application, script, or code) can be written in any form of programming language, including compiled languages, interpreted languages, declarative languages, and procedural languages, and the computer program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, libraries, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a field programmable gate array (“FPGA”) or an application specific integrated circuit (“ASIC”). Such a special purpose circuit may be referred to as a computer processor even if it is not a general-purpose processor.

In embodiments, the controller 122 may determine whether the detected value(s) is outside of a predetermined range of the threshold value. In further embodiments, the controller 122 may control the first expansion valve 112 based on only the discharge superheat. The controller 122 may be configured to increase a size of the opening of the first expansion valve 112 when the first sensor 116 detects at least one of the discharge superheat, the discharge pressure, and the discharge temperature is at or above the first threshold value. The controller 122 may be configured to control a size of the opening of the first expansion valve 112 based on the detected at least one of the suction superheat, the suction pressure, and the suction temperature. However, it is contemplated and possible that the controller 122 controls the first expansion valve 112 based on only the discharge superheat. In some embodiments, the controller 122 may control the expansion valves 112, 114 based on an elapsed time period, where after a predetermined time period passes, the controller 122 may move the expansion valves 112, 114 from substantially open, substantially closed, or one of each, to another position. The predetermined time period may begin when the vehicle starts, such as when the engine begins operation. After the predetermined time period passes, the controller 122 may control the expansion valves 112, 114 to open and/or close the valves 112, 114 to adjust the amount of fluid flow through the refrigerant loop.

Superheat and quality may each be calculated (e.g., by the aforementioned processor within the controller 122) based on a detected pressure and temperature, where the controller 122 may store a pressure and temperature map in storage for compressor suction and/or compressor discharge and determine the superheat based on a comparison between the detected pressure and temperature against the pressure and temperature map. As such, a sensor may detect superheat by including each of a pressure sensor and a temperature sensor, enabling the controller 122 to determine the superheat based on the detected pressure and temperature. In some embodiments, a pressure and temperature map may be used in conjunction with at least one of a compressor suction, compressor speed, compressor discharge, and a mix outlet to determine a size of an opening of the first expansion valve 112 and/or second expansion valve 114. It is further contemplated and possible that discharge and suction conditions of the second compressor 130 may be detected or calculated in other manners, such as based on a heater core coolant loop temperature or a chiller coolant loop temperature. The controller 122 may additionally control the expansion valves 112, 114 in the following manner: increases a size of the opening of one of the expansion valves 112, 114 if the compressor speed increases, and increases a size of the opening of one of the expansion valves 112, 114 if the compressor speed remains constant and suction or discharge temperature increases.

The bypass loop 106 may include the second expansion valve 114 configured to control fluid flow through the bypass loop 106 of the refrigerant loop 102, a first end 132 connected to the main loop 104 between the sensor 116 and the first heat exchanger 124, and a second end 134 connected to the main loop 104 between the second heat exchanger 126 or the first expansion valve 112 and the second compressor 130. The second expansion valve 114 may be positioned between the first end 132 and the second end 134. The second compressor 130 may produce a gas from the refrigerant passing therethrough, where the gas from the second compressor 130 passes through the bypass loop 106 and the gas passes through the heat exchanger 124 to convert to a gas-liquid 2-phase mixture to pass through the main loop 104.

The controller 122 may be configured to control the opening of the first expansion valve 112 to be fully closed when the external sensor 120 detects an ambient temperature below a second threshold value. The second threshold value may be, for example, 0° C. The controller 122 may be configured to control the opening and closing of the first expansion valve 112 and/or the second expansion valve 114 based on the detected suction superheat, suction quality, suction pressure, or suction temperature from the second sensor 118. The controller 122 may control the size of the opening of the first expansion valve 112 when the first sensor 116 detects at least one of the discharge superheat, the discharge pressure, and the discharge temperature at or above a first threshold value, and the controller 122 may control a size of the opening of the second expansion valve 114 based on at least one of the suction superheat, the suction pressure, and the suction temperature. The controller 122 may control the size of the opening of the first expansion valve 112 and the size of the opening of the second expansion valve 114 to be fully open or having a predetermined initial value that is less than fully open when the external sensor 120 detects an ambient temperature below a third threshold value. The controller 122 may control the opening and closing of the first expansion valve 112 and the second expansion valve 114 independently of one another. In embodiments including a coolant loop 108, one of the sensors may be configured to detect a temperature of a coolant in the coolant loop 108, where the controller 122 is configured to control the opening and closing of the first expansion valve 112 and the second expansion valve 114 based on the detected temperature of the coolant.

In embodiments, the controller 122 may store in storage a pressure and temperature map which associates discharge pressure and the discharge temperature, the suction pressure and the suction temperature, or both. The pressure and temperature map includes a mapping of pressure and temperature values, along with a predetermined opening amount or percentage associated with pairs of the pressure and temperature values. The controller 122 may use a detected temperature and/or a detected pressure to look-up via the pressure and temperature map an appropriate opening, or predetermined opening size, for one of the first and second expansion valves, 112, 114. For example, when pressure is at 0.2 MPa and temperature is at 30° C., the pressure and temperature map may have an opening of the relative expansion valve set at 30% of max fluid flow. The controller 122 is configured to control the opening and closing of the first expansion valve based on the pressure and temperature map in the above manner. In further embodiments, the controller 122 may control the opening and closing of the expansion devices based on the compressor speed. For example, when the controller 122 detects an increase in the compressor speed, the controller 122 is configured to increase the opening of the expansion device(s). For further example, if the detected compressor speed remains constant and the detected suction temperature or the detected discharge temperature increases, the controller 122 is configured to increase the opening of the expansion device(s).

The controller 122 may define a plurality of operation modes for controlling parameters associated with the refrigerant loop 102. The plurality of operation modes may include a normal startup mode and a cold startup mode, wherein the normal startup mode is triggered when the detected ambient temperature is outside of a range of optimal temperatures for heating the parts of the vehicle. For example, the normal startup mode may be triggered when the detected ambient temperature is between 15° C. and 30° C. The cold startup mode may be triggered when a detected ambient temperature is below 0° C. When the controller 122 selects the cold startup mode from the plurality of operation modes, the controller 122 may fully open or close the first and second expansion valves 112, 114 to increase refrigerant flow through the second compressor 130. In embodiments, the plurality of operation modes may include a switch-activated mode that is triggered by an activation of a switch that is communicatively coupled to the controller 122 for sending a signal to the controller 122 for activating the switch-activated mode. The switch-activated mode may include the same functions as the cold startup mode, including selecting the opening of the first and second expansion valves 112, 114 at a fully open, fully closed, substantially open, substantially closed, or intermediate position between fully open and fully closed. When the switch-activated mode is activated, the controller 122 may be configured to control the opening of the first expansion valve 112 to be fully open, fully closed, substantially open, substantially closed, or intermediate position between fully open and fully closed, and control the opening of the second expansion valve 114 to be fully open, fully closed, substantially open, substantially closed, or intermediate position between fully open and fully closed.

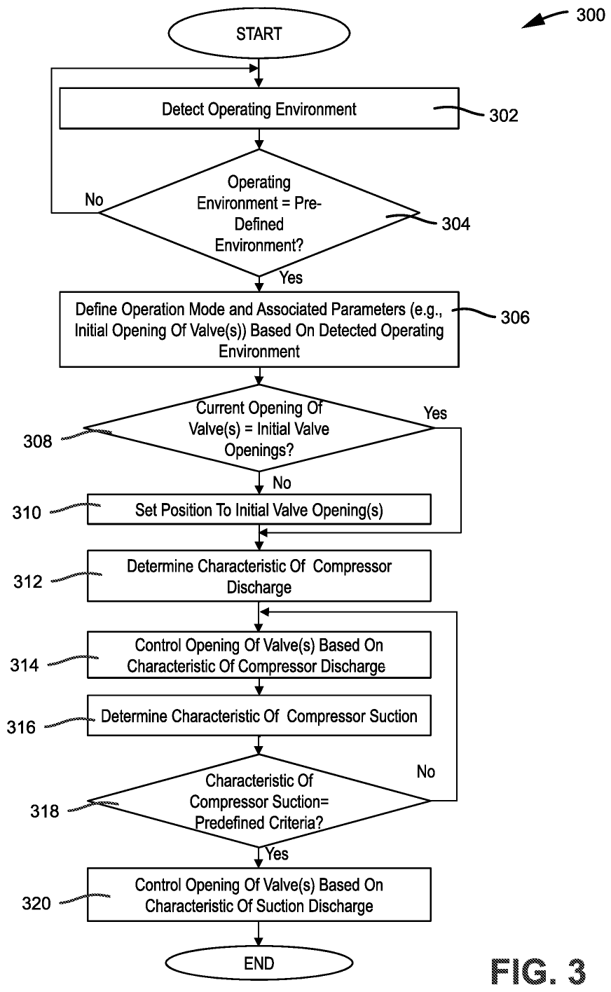

Referring now to FIG. 3, a flowchart of a method 300 of operating the refrigerant loop is depicted. The method may be performed by one or more of the controllers and/or processors disclosed herein. At step 302, the method 300 may include detecting an operating environment. The operating environment may be an ambient temperature, such as disclosed herein. At step 304, the method 300 may include determining whether the operating environment is a pre-defined environment. If the operating environment is determined to not be the pre-defined environment, the method 300 returns to step 302. If the operating environment is determined to be the pre-defined environment, the method proceeds to step 306. At step 306, the method 300 may include defining the operation mode and associated parameters (e.g., initial opening of valve(s) 112, 114) based on the detected operating environment. The initial opening of the expansion valves 112, 114 may be substantially open or substantially closed. The operation mode may be selected from a plurality of operation modes, wherein the operation mode comprises a cold startup mode that is triggered when a detected ambient temperature is below 0° C.

At step 308, the method 300 may include determining whether the current opening of the expansion valves 112, 114 is the initial opening of the expansion valves 112, 114. In some embodiments, the method 300 may determine whether the current opening is outside of a predetermined range of the initial opening. If the current opening is not equal to the initial opening, the method 300 may proceed to step 310 where the current opening of the expansion valves 112, 114 is adjusted to be the initial valve openings. If the current opening is equal to the initial opening, the method 300 may proceed to step 312, where a characteristic of compressor discharge is determined. The characteristic of compressor discharge may be a discharge superheat, a discharge pressure, and/or a discharge temperature.

At step 314, the method 300 may include control of the opening of the expansion valves 112, 114 based on the characteristic of compressor discharge. The opening may be controlled by changing a size of the opening of the expansion valve if the discharge superheat, the discharge pressure, the discharge temperature, the suction superheat, the suction pressure, and/or the suction temperature passes the threshold value or is outside of the predetermined range of the threshold value. In embodiments, the threshold value may be in a range of 0° C. to 30° C. At step 316, the method 300 may include determining a characteristic of compressor suction, where the characteristic of compressor suction may be a suction superheat, a suction pressure, and/or a suction temperature.

At step 318, the method 300 may determine whether the characteristic of compressor suction is equal to or outside of a predetermined range of a predefined criteria. If the characteristic of compressor suction is not equal to the predefined criteria, the method 300 may return to step 314. If the characteristic of compressor suction is equal to the predefined criteria, the method 300 may proceed to step 320. At step 320, the method 300 may include control of the opening of the expansion valves 112, 114 based on the characteristic of suction discharge.

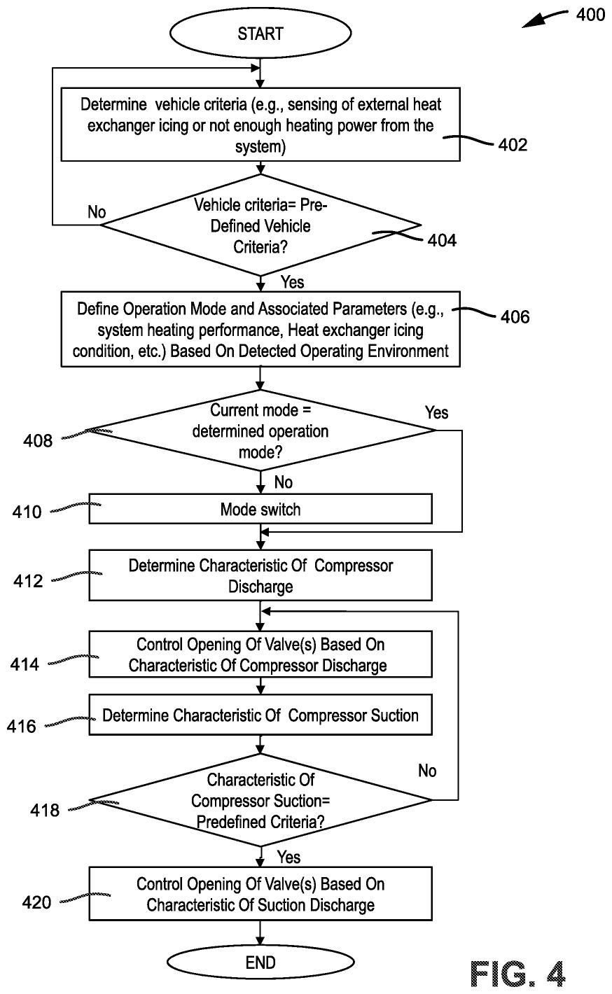

Referring now to FIG. 4, a flowchart of another method 400 of operating the refrigerant loop is depicted. The method may be performed by one or more of the controllers and/or processors disclosed herein. At step 402, the method 400 may determine vehicle criteria, such as sensing of external heat exchanger icing via a sensor or heating power from the system being below a threshold value. Heating power may be determined by a temperature of airflow out of the heating system, temperature of coolant or refrigerant, or the like. At step 404, the method 400 may determine whether the vehicle criteria is equal to or outside of a predetermined range of a pre-defined vehicle criteria, such as disclosed herein. If the vehicle criteria is not equal to the pre-defined vehicle criteria, the method 400 returns to step 402. If the vehicle criteria is equal to the pre-defined vehicle criteria, the method 400 proceeds to step 406. At step 406, the method 400 may include defining operation mode and associated parameters (e.g., system heating performance, heat exchanger icing condition, etc.) based on a detected operating environment.

At step 408, the method 400 may include determining whether the current mode is equal to the determined operation mode where, if the current mode is the determined operation mode, the method 400 proceeds to step 410 and, if the current mode is not the determined operation mode, the method 400 proceeds to step 412. At step 410, the method 400 may include switching the current operation mode. At step 412, the method 400 may include determining a characteristic of compressor discharge and, at step 414, the method 400 may include controlling the opening of the expansion valves 112, 114 based on the characteristic of compressor discharge.

At step 416, the method 400 may include determining the characteristic of compressor suction and, at step 418, the method 400 may include determining whether the characteristic of compressor suction is equal to or outside of a predetermined range of a predefined criteria. If the characteristic of compressor suction is not equal to the predefined criteria, the method 400 may return to step 414. If the characteristic of compressor suction is equal to the predefined criteria, the method 400 may proceed to step 420. At step 420, the method 400 may include controlling opening of the expansion valves 112, 114 based on the characteristic of suction discharge.

The current disclosure is further defined with respect to the below clauses:

Clause 1. A refrigerant loop including: at least one heat exchanger; a first expansion valve configured to control flow of a refrigerant through the refrigerant loop; a compressor; at least one sensor for detecting at least one of a discharge superheat (SH) from the compressor, a discharge pressure, a discharge temperature, and a compressor speed; and a controller communicatively coupled to the at least one sensor, the controller controls an opening and closing of the first expansion valve based on the at least one of detected discharge SH, the discharge pressure, the discharge temperature, and the compressor speed, the controller changes a size of an opening of the first expansion valve such that the at least one of the detected discharge superheat, the discharge pressure, the discharge temperature, and the compressor speed is within a predetermined range of a first value.

Clause 2. The refrigerant loop of clause 1, further including: a second sensor communicatively coupled to the controller, the second sensor is positioned at a suction side of the compressor and is configured to detect at least one of a suction superheat, a suction pressure, and a suction temperature is at or above a second threshold value, wherein the first sensor is positioned at a discharge side of the compressor, wherein the controller changes a size of the opening of the first expansion valve when the first sensor detects at least one of the discharge superheat, the discharge pressure, and the discharge temperature is at or above the first threshold value, and the controller controls a size of the opening of the first expansion valve based on the detected at least one of the suction superheat, the suction pressure, and the suction temperature.

Clause 3. The refrigerant loop of either of clauses 1 and 2, further including: an external sensor communicatively coupled to the controller, wherein the controller controls the opening of the first expansion valve to be substantially closed when the external sensor detects an ambient temperature below a second threshold value.

Clause 4. The refrigerant loop of clause 3, wherein the second threshold value is 0° C.

Clause 5. The refrigerant loop of any of the above clauses, wherein the controller controls the first expansion valve based on only the discharge superheat.

Clause 6. The refrigerant loop of any of the above clauses, further including: a second sensor positioned at a suction side of the compressor, the second sensor is configured to detect one of a suction superheat, suction quality, suction pressure, or suction temperature of the compressor; and a bypass loop including a second expansion valve, wherein the controller is configured to control the opening and closing of the second expansion valve based on the detected suction superheat, suction quality, suction pressure, or suction temperature.

Clause 7. The refrigerant loop of any of the above clauses, wherein a pressure and temperature map is stored in the controller, and the controller is configured to control the opening of the first expansion valve based on at least one of the pressure and temperature map and a detected discharge pressure and a detected discharge temperature.

Clause 8. The refrigerant loop of any of the above clauses, wherein the at least one sensor includes a first sensor and a second sensor, the first sensor is configured to detect at least one of the discharge superheat, the discharge pressure, and the discharge temperature, the second sensor is configured to detect at least one of a suction superheat, a suction pressure, a suction temperature, and wherein the controller is configured to store a pressure and temperature map which associates one of the discharge superheat, the discharge pressure, or the discharge temperature, and the suction superheat, the suction pressure, or the suction temperature.

Clause 9. The refrigerant loop of the preceding clause, wherein if the detected compressor speed remains constant and the detected suction temperature or the detected discharge temperature increases, the controller is configured to increase the opening of the first expansion device.

Clause 10. The refrigerant loop of any of the above clauses, wherein if the controller detects an increase in the compressor speed, the controller is configured to increase the opening of the first expansion device.

Clause 11. A refrigerant loop including: a main loop including: at least one heat exchanger; a first expansion valve configured to control flow of a refrigerant through the refrigerant loop; a compressor; a sensor for detecting at least one of a discharge superheat (SH) from the compressor, a discharge temperature, a discharge pressure, a suction SH, a suction temperature, a suction pressure, a temperature of a refrigerant, and a time period; a bypass loop including a second expansion valve configured to control flow of the refrigerant through the refrigerant loop; and a controller that controls the opening and closing of the first expansion valve and the second expansion valve based on the detected discharge SH, the discharge temperature, the discharge pressure, the suction SH, the suction temperature, the suction pressure, the temperature of the refrigerant, and the time period.

Clause 12. The refrigerant loop of clause 11, wherein the at least one heat exchanger of the main loop includes a first heat exchanger positioned between the sensor and the first expansion valve, and a second heat exchanger positioned between the first expansion valve and the compressor, and the bypass loop includes a first end connected to the main loop between the sensor and the first heat exchanger, and a second end connected to the main loop between the second heat exchanger and the compressor, wherein the second expansion valve is positioned between the first end and the second end.

Clause 13. The refrigerant loop of clause 12, wherein only gas passes through the bypass loop.

Clause 14. The refrigerant loop of clause 13, wherein the controller controls the opening and closing of the first expansion valve and the second expansion valve independently of one another.

Clause 15. The refrigerant loop of any one of clauses 11-14, wherein the controller controls the size of the opening of the first expansion valve when the first sensor detects at least one of the discharge superheat, the discharge pressure, and the discharge temperature at or above a first threshold value, and the controller controls a size of the opening of the second expansion valve based on at least one of a suction superheat, a suction pressure, and a suction temperature.

Clause 16. The refrigerant loop of any one of clauses 11-15, further including an external sensor communicatively coupled to the controller, wherein the controller controls the opening of the first expansion valve to be substantially closed and the second expansion valve to be substantially open when the external sensor detects an ambient temperature below a third threshold value.

Clause 17. A heating system including: the refrigerant loop of any one of clauses 11-16; and a coolant loop connected to the refrigerant loop at the at least one heat exchanger of the refrigerant loop, wherein the sensor is configured to detect a temperature of a coolant in the coolant loop, and the controller is configured to control the opening and closing of the first expansion valve and the second expansion valve based on the detected temperature of the coolant.

Clause 18. The refrigerant loop of any one of clauses 11-17, wherein the second expansion valve has a max size of the opening that is greater than a max size of the opening of the first expansion valve.

Clause 19. The refrigerant loop of any one of clauses 11-18, wherein the first expansion valve and the second expansion valve are controlled by the controller under a coupling logic/proportional logic with a same control signal.

Clause 20. A method of operating a refrigerant loop, the method including: defining an initial opening of an expansion valve, wherein the initial opening is substantially open or substantially closed; detecting a discharge superheat from a compressor; determining whether the discharge superheat is outside of a predetermined range of a threshold value; and changing a size of the opening of the expansion valve if the discharge superheat is outside of the predetermined range of the threshold value.

Clause 21. The method of clause 20, further including defining an operation mode of a plurality of operation modes, wherein the operation mode includes a cold startup mode that is triggered when a detected ambient temperature is below 0° C.

Clause 22. The method of either of clauses 20 and 21, further including maintaining the opening of the expansion valve if the discharge superheat is below the threshold value.

Clause 23. The method of any of clauses 20-22, wherein the threshold value is in a range of 0° C. to 50° C.

Clause 24. The method of any of clauses 20-23, further including defining an initial opening of a second expansion valve, wherein the initial opening of the second expansion valve is fully open.

Clause 25. The method of any of clauses 20-24, further including detecting one of a suction superheat, suction quality, suction pressure, or suction temperature of the compressor, and controlling the opening of the second expansion valve based on the detected suction superheat, suction quality, suction pressure, or suction temperature.

Clause 26. A refrigerant loop including: at least one heat exchanger; a first expansion valve configured to control flow of a refrigerant through the refrigerant loop; a compressor; at least one sensor for detecting at least one of a suction superheat (SH) into the compressor, a suction pressure, a suction temperature, and a compressor speed; and a controller communicatively coupled to the at least one sensor, the controller controls an opening and closing of the first expansion valve based on the at least one of detected suction SH, the suction pressure, the suction temperature, and the compressor speed, the controller changes a size of an opening of the first expansion valve when at least one of the suction superheat, the suction pressure, the suction temperature, and the compressor speed is outside of a predetermined range of a first value.

Clause 27. The refrigerant loop of clause 26, wherein a pressure and temperature map which associates suction pressure and suction temperature is stored by the controller, and the controller is configured to control the opening and closing of the first expansion valve based on at least one of the pressure and temperature map and a detected discharge pressure and a detected discharge temperature.

Clause 28. The refrigerant loop of either of clauses 26 and 27, wherein the controller is configured to calculate a compressor suction quality based on at least one of the detected suction SH, the suction pressure, the suction temperature, the compressor speed, and a size of the first expansion valve opening, and the controller controls the opening of the first expansion valve based on the compressor suction quality.

Clause 29. A refrigerant loop including: at least one heat exchanger; a first expansion valve configured to control flow of a refrigerant through the refrigerant loop; a compressor; at least one sensor for detecting at least one of a discharge superheat (SH) from the compressor, a discharge pressure, a discharge temperature, a suction superheat, a suction pressure, a suction temperature, and a compressor speed; and a controller communicatively coupled to the at least one sensor, the controller controls an opening and closing of the first expansion valve based on the at least one of detected discharge SH, the discharge pressure, the discharge temperature, the suction SH, the suction pressure, the suction temperature, and the compressor speed, the controller changes a size of an opening of the first expansion valve when at least one of the detected discharge superheat, the discharge pressure, the discharge temperature, the suction SH, the suction pressure, the suction temperature, and the compressor speed is outside of a predetermined range of a first value.

Clause 30. A method of operating a refrigerant loop, the method including: defining an initial opening of an expansion valve, wherein the initial opening is substantially open or substantially closed; detecting a suction superheat into a compressor; determining whether the suction superheat is outside of a predetermined range of a threshold value; and changing a size of the opening of the expansion valve if the suction superheat is outside of a predetermined range of the threshold value.

Clause 31. A method of operating a refrigerant loop, the method comprising: defining an initial opening for a first expansion valve, wherein the initial opening for the first expansion valve is substantially open or substantially closed; defining an initial opening for a second expansion valve, wherein the initial opening for the expansion valve is substantially open or substantially closed; receiving at least one characteristic of a compressor, a heater core, and coolant flowing through a coolant loop, and; determining a target opening for the first expansion valve based on the at least one characteristic of at least one of the compressor, the heater core, and the coolant; determining a target opening for the second expansion valve based on the at least one characteristic of at least one of the compressor, the heater core, and the coolant; setting the initial opening for the first expansion valve to the target opening for the first expansion valve in response to the at least one characteristic of the at least one of the compressor, the heater core, and the coolant meeting a predetermined condition; and setting the initial opening for the second expansion valve to the target opening for the second expansion valve in response to the at least one characteristic of the at least one of the compressor, the heater core, and the coolant meeting a predetermined condition.

Clause 32. The method of operating the refrigerant loop of clause 31, wherein the at least one characteristic is at least one of a discharge superheat (SH) from the compressor, a discharge temperature, a discharge pressure, a suction SH, a suction temperature, a suction pressure, a temperature of a refrigerant, a temperature of the coolant, a temperature associated with the heater core, a compressor speed, and a time period;

Clause 33. A method of operating a refrigerant loop, the method comprising: defining an initial opening for a first expansion valve, wherein the initial opening for the first expansion valve is substantially open or substantially closed; defining an initial opening for a second expansion valve, wherein the initial opening for the expansion valve is substantially open or substantially closed; receiving at least one of a discharge superheat (SH) from the compressor, a discharge pressure, a discharge temperature; and determining a target opening for the first expansion valve based on at least one of a discharge superheat (SH) from the compressor, a discharge pressure, a discharge temperature; determining a target opening for the second expansion valve based at least one of a discharge superheat (SH) from the compressor, a discharge pressure, a discharge temperature; in response to the initial opening for the first expansion valve not being equal to the target opening for the first expansion valve, setting the initial opening for the first expansion valve to the target opening for the first expansion valve based on the comparison of the at least one of a discharge superheat (SH) from the compressor, a discharge pressure, a discharge temperature to a predetermined condition; and in response to the initial opening for the second expansion valve not being equal to the target opening for the second expansion valve, setting the initial opening for the second expansion valve to the target opening for the second expansion valve based on the comparison of the at least one of a discharge superheat (SH) from the compressor, a discharge pressure, a discharge temperature to a predetermined condition.

Clause 34—A refrigerant loop comprising: a main loop comprising: at least one heat exchanger; a first expansion valve configured to control flow of a refrigerant through the refrigerant loop; a compressor; a bypass loop comprising a second expansion valve configured to control flow of the refrigerant through the refrigerant loop; and a controller configured to control the opening and closing of the first expansion valve and the second expansion valve based on a characteristic associated with at least one of the compressor, ta heater core, and coolant flowing through a coolant loop.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A refrigerant loop comprising:
a main loop comprising:
at least one heat exchanger;
a first expansion valve configured to control flow of a refrigerant through the refrigerant loop;
a compressor;
a sensor for detecting at least one of a discharge superheat (SH) from the compressor, a discharge temperature, a discharge pressure, a suction SH, a suction temperature, a suction pressure, a temperature of a refrigerant, and a time period;
a bypass loop comprising a second expansion valve configured to control flow of the refrigerant through the refrigerant loop; and
a controller that controls the opening and closing of the first expansion valve and the second expansion valve based on the at least one of the detected discharge SH, the discharge temperature, the discharge pressure, the suction SH, the suction temperature, the suction pressure, the temperature of the refrigerant, and the time period.

2. The refrigerant loop of claim 1, wherein the at least one heat exchanger of the main loop comprises a first heat exchanger positioned between the sensor and the first expansion valve, and a second heat exchanger positioned between the first expansion valve and the compressor, and
the bypass loop comprises a first end connected to the main loop between the sensor and the first heat exchanger, and a second end connected to the main loop between the first expansion valve and the second heat exchanger, wherein the second expansion valve is positioned between the first end and the second end.

3. The refrigerant loop of claim 2, wherein only gas passes through the bypass loop.

4. The refrigerant loop of claim 3, wherein the controller controls the opening and closing of the first expansion valve and the second expansion valve independently of one another.

5. The refrigerant loop of claim 1, wherein the controller controls the size of the opening of the first expansion valve based on at least one of the discharge superheat, the discharge pressure, and the discharge temperature, and the controller controls a size of the opening of the second expansion valve based on at least one of a suction superheat, a suction pressure, and a suction temperature.

6. The refrigerant loop of claim 1, further comprising an external sensor communicatively coupled to the controller, wherein the controller controls the opening of the first expansion valve to be substantially closed and the second expansion valve to be substantially open when the external sensor detects an ambient temperature below a third threshold value.

7. A heating system comprising:
the refrigerant loop of claim 1; and
a coolant loop connected to the refrigerant loop at the at least one heat exchanger of the refrigerant loop,
wherein the sensor is configured to detect a temperature of a coolant in the coolant loop, and the controller is configured to change a size of the opening of the first expansion valve and the opening of the second expansion valve based on the detected temperature of the coolant.

8. A method of operating a refrigerant loop, the method comprising:
defining an initial opening of an expansion valve, wherein the initial opening is substantially open or substantially closed;
detecting a characteristic of a discharge side of a compressor;
determining whether the characteristic of the discharge side of the compressor is outside of a predetermined range of a threshold value; and
changing a size of the opening of the expansion valve in response to the characteristic of the discharge side of the compressor being outside of the predetermined range of the threshold value.

9. The method of claim 8, further comprising defining an operation mode of a plurality of operation modes, wherein the operation mode comprises a cold startup mode that is triggered when a detected ambient temperature is below 0° C.

10. The method of claim 9, further comprising decreasing the size of the opening of the expansion valve if the discharge superheat is below the threshold value.

11. The method of claim 9, wherein the threshold value is in a range of 0° C. to 50° C.

12. The method of claim 9, further comprising defining an initial opening of a second expansion valve, wherein the initial opening of the second expansion valve is fully open.

13. The method of claim 9, further comprising detecting one of a suction superheat, suction quality, suction pressure, or suction temperature of the compressor, and controlling the opening of the second expansion valve based on the detected suction superheat, suction quality, suction pressure, or suction temperature.

14. The method of claim 9, wherein the plurality of operation modes comprises a switch-activated mode that is triggered by an activation of a switch that is communicatively coupled to the controller, and the switch-activated mode includes controlling the opening of the first expansion valve to be substantially open.

15. A method of operating a refrigerant loop, the method comprising:
determining a characteristic of a discharge side of a compressor;
controlling an expansion valve using a first method, wherein the first method comprises control logic that is based on the characteristic of a discharge side of the compressor;
determining a characteristic of a suction side of the compressor; and
in response to the characteristic of the suction side of the compressor meeting predefined criteria, controlling the expansion valve using a second method, wherein the second method comprises control logic is based on the characteristic of the suction side of the compressor.

16. The method of claim 15, wherein the characteristic of the discharge side of the compressor is at least one of a discharge temperature, a discharge pressure, and a discharge superheat, and the characteristic of the suction side of the compressor is at least one of a suction temperature, a suction pressure, and a suction superheat.

17. A method of operating a refrigerant loop, the method comprising:
detecting a condition associated with an operating environment of the refrigerant loop;
defining an operation mode and associated parameters for at least one of a first expansion valve and a second expansion valve based on the detected condition, wherein the associated parameters include:
a first initial opening for the first expansion valve, wherein the initial opening for the first expansion valve is substantially open or substantially closed;
a second initial opening for the second expansion valve, wherein the initial opening for the expansion valve is substantially open or substantially closed;
setting the first expansion valve to the first initial opening and the second expansion valve to the second initial opening;
determining a characteristic of a discharge side of the compressor;
controlling the opening of at least one of the first expansion valve and the second expansion valve based on the characteristic of the discharge side of the compressor;
determining a characteristic of a suction side of the compressor;
in response to the characteristic of the suction side of the compressor meeting a predetermined characteristic, controlling the opening of at least one of the first expansion valve and the second expansion valve based on the characteristic of suction discharge.

18. The method of operating the refrigerant loop of claim 17, wherein the at least one characteristic is at least one of a discharge superheat (SH) from the compressor, a discharge temperature, a discharge pressure, a suction SH, a suction temperature, a suction pressure, a temperature of a refrigerant, a temperature of the coolant, a temperature associated with the heater core, a compressor speed, and a time period.

19. A refrigerant loop comprising:
a main loop comprising:
at least one heat exchanger;
a first expansion valve configured to control flow of a refrigerant through the refrigerant loop;
a compressor;
a first sensor configured to output a characteristic of a suction side of the compressor;
a second sensor configured to output a characteristic of a discharge side of the compressor;
a bypass loop comprising a second expansion valve configured to control flow of the refrigerant through the refrigerant loop; and
a controller configured to:
in response to a condition associated with an operating environment of the refrigerant loop, control the opening and closing of at least one of the first expansion valve and the second expansion valve using a first method, wherein in the first method comprises control logic that is based on the characteristic of the discharge side of the compressor; and
in response to a characteristic of a suction side of the compressor meeting a predefined criteria, switching control of the opening and closing of at least one of the first expansion valve and the second expansion valve using a second method, wherein in the second method comprises control logic that is based on the characteristic of the suction side of the compressor.

20. The refrigerant loop of claim 19, wherein the characteristic of the discharge side of the compressor is at least one of a discharge temperature, a discharge pressure, and a discharge superheat, and the characteristic of the suction side of the compressor is at least one of a suction temperature, a suction pressure, and a suction superheat.
